(19) United States
(12) Patent Application Publication
(10) Pub. No.: US 2008/0030326 A1
(43) Pub. Date: Feb. 7, 2008

(54) Dynamic stock tracking method and system

(75) Inventors: Zvi Gal, Natania (IL); Moshe Jacob, Binyamina (IL)

Correspondence Address: Martin D. Moynihan;PRTSI, Inc., P.O. Box 16446, Arlington, VA, 22215, US

(73) Assignee: Diamond Location Ltd., Ramat-Gan (IL)

(21) Appl. No.: 11/723,716

(22) Filed: Mar. 21, 2007

Related U.S. Application Data
(60) Provisional application No. 60/841,241, filed on Aug. 31, 2006.
(60) Provisional application No. 60/783,831, filed on Mar. 21, 2006.

(51) Int. Cl. G08B 1/08

(52) U.S. Cl. 340/540; 700/215; 711/100

(57) ABSTRACT

A dynamic stock tracking method and system for continuously tracking stock contained within a receptacle by applying to the receptacle an identification device identifying the respective receptacle and containing information regarding its contents; applying to the receptacle one or more condition sensors for sensing one or more preselected conditions of the receptacle when at a particular location; transmitting by wireless a signal identifying the respective receptacle and whether or not a preselected condition has been sensed; receiving the transmitted signal at another location; and utilizing the received signal for continuously tracking the stock contained within the receptacle and whether or not a preselected condition has occurred. The preferred embodiments described are for tracking stocks of diamond and jewelry contained within receptacles, but the invention could also be used for tracking arms and weapons, or other objects requiring close security control.

### RELATED APPLICATIONS

The present application is a continuation-in-part, and claims the priority dates, of U.S. Provisional Patent Applications 60/783,831, filed on Mar. 21, 2006, and 60/841,241, filed Aug. 31, 2006, the contents of which applications are incorporated herein by reference.

### FIELD AND BACKGROUND OF THE INVENTION

The present invention relates to a dynamic stock tracking method and system for continuously tracking stock contained within a receptacle. The invention is particularly useful for tracking diamonds, other gemstones, and jewelry containing such gemstones, and the invention is therefore described below with respect to this application.

Stock programs are available that can track the stock regarding records in a database. All common stock programs identify the stock by a unique stock identification (ID) and are usually capable of adding other identification fields according to the stock being tracked. In diamonds, other gemstones and jewels, the identification fields might contain additional information regarding the stone/jewel. For example, stocks of diamonds/gemstones may contain information regarding: stock ID, quantity, weight, weight unit (carat, gram), color, clarity, cut, other gemological information as polish, symmetry, cost, price, rapaport price, current location, quantities and weight out on memo, quantities and weight currently at office, last sold price, stone image, stone certification images, history of purchases, history of sales, etc. Stocks of jewels may contain information regarding: stock ID, stock name, quantity, weight, precious stones the jewel contains, the different parts of the jewel structure (BOM), stones weight, metal information of the jewel (silver, gold, gold type 14 k, 18 k etc.), jewel out on memo, jewel purchase history, jewel sales history, etc.

In all stock programs, particularly in diamonds/gemstones and jewel stock programs, the user is the one that controls the information inserted into the database using the interface of the stock program. The user can perform database procedures on the stock that simulate transactions occurring in the real world. Such transactions may include adding goods to the stock, which would involve filling in the appropriate identifying fields that best describe the stock. Sale transactions may include selling goods from the stock, which would involve again filling in information describing the sold goods, as well information regarding the sale itself (sale price, customer name, sale date etc.). Memo-out transactions may include giving the goods out on consignment in which case a memorandum statement would be prepared, indicating that the goods are physically out of the stock (to a consignee) but not yet sold. Returning memo-out transactions would be the opposite; i.e., they would involve receiving the goods back into the stock, and giving a credit note to the consignee.

Stock programs generally have provision for best describing the real world transactions which happen to the stock, i.e., purchased, sold out on memo, on consignment or brokerage, returned from consignment or brokerage, etc. Such stock programs generally rely on the user to do the data handling, e.g., to fill the correct information regarding each transaction of the stock. The stock programs provide procedures which, in the end, are translated to database transactions that are kept as database table records. Each stock program uses different tables with different fields, but in the end, all programs try to represent the real world and give the program user a correct picture on the status of the respective stock, i.e., how much and where.

However, the correct picture on one's stock status generally lacks complete information for one or more of the following reasons:

1. User Responsible for Data Capturing

The user is the one who fills in the information regarding the stock transactions and especially when goods have to move out of the stock (sales, memo out) or return to the stock (returned memo out, returned brokerage) etc. However, data capturing mistakes can be made in every level of the transactions. Moreover, other errors may include data capturing mistakes to cover previous mistakes, and sometimes to cover more suspicious acts, such as stock loss, theft, etc.

2. Full Representation of Transactions

All data captured in the database represents stock movement out of the office to another location (to client, to consignee, to broker, etc.), or within the office to a virtual location (mixes in the stock or between virtual locations etc.). However, all data captured in the database sometimes does not fully represent the accurate transaction occurring with respect to the stock, such as, whether the stock really left the office, or if moved between virtual location, whether the stock really moved at all. The traditional stock programs do not capture all such events.

3. Corrected Stock Status

As explained above, the real interest of the stockowner is the current stock status, i.e., “where my stock is, and how much do I have”. With traditional stock programs this information is based on the user accuracy of data capturing. Moreover, no stock programs can really tell whether the stock that was supposed to be in the office is really in the office. To be able to tell this with traditional stock programs, one has to physically check (e.g., visual eye contact) each stock item with the corresponding stock item in the computer program. No program is presently available that can provide the user with an accurate report, at a glance, of the actual stock status at any time such a report may be desired.

4. Level of Information

In traditional stock programs the information that is kept in the database represent global transactions of the stock, such as purchase, sale, memo out, memo in, return memo out, out on brokerage, mixes, etc. Theses transactions include changes in stock structure, i.e. if a specific stock parcel has changed in quantity, weight, stock location or virtual stock location, price etc. However, if would also be desirable to provide information regarding any physical movement (e.g., a parcel movement of 10 cm from point A to point B), any opening of the parcel box (e.g., the box was opened, and then immediately closed), any touching of the parcel (e.g., someone touched the parcel once), or any lifting of a parcel off the table (e.g., someone lifted the parcel and then put it back on the table), which events are not captured at all in current stock programs.

### OBJECTS AND BRIEF SUMMARY OF THE PRESENT INVENTION

An object of the present invention is to provide a dynamic stock tracking method and system having advantages in one or more of the above respects. Another object of the invention is to provide such a tracking method and system particularly useful for continuously tracking gemstones and jewelry, but which can also be used for tracking other items requiring close control, such as arms and munitions.

According to one broad object of the present invention, there is provided a dynamic stock tracking method for continuously tracking stock contained within a receptacle, comprising: applying to the receptacle an identification device identifying the respective receptacle and containing information regarding its contents; applying to the receptacle one or more condition sensors for sensing one or more preselected conditions of the receptacle; transmitting by wireless to another location, a signal identifying the respective receptacle and whether a preselected condition has been sensed; receiving the transmitted signal at the another location; and utilizing the received signal for continuously tracking the stock contained within the receptacle and whether a preselected condition has occurred.

The invention is particularly useful where the identification device is an RFID (radio frequency identification device), in which case the transmitted signal is an RF signal. However, the invention can also be advantageously used in a method wherein the identification device is an infrared identification device (IRID), e.g., where the remote receiver is located in the same room as the stock being tracked, in which case the transmitted signal is an IR signal.

The invention is described below wherein the stock is precious gems or jewelry contained within the receptacle. In such applications of the invention, the one or more preselected conditions sensed by the condition sensors could include: a lifting of the receptacle off a table or other horizontal surface, an opening of the receptacle, a touching of the receptacle, a physical movement of the receptacle, a change in weight of the receptacle, a change in the ambient temperature of the receptacle, and/or the absence of physical movement of the receptacle for a predetermined time period.

In the preferred embodiments described below, the wireless signal is transmitted at periodic time intervals. In some applications, however, the signal could be transmitted in response to an interrogating signal, such as in a transponder arrangement. The transmitted signal may be used to actuate a signaling, control or communication device.

According to another aspect of the present invention, there is provided a dynamic stock tracking system for continuously tracking stock, comprising: a receptacle for receiving the stock; an identification device carried by the receptacle for identifying the receptacle and containing information regarding its contents; one or more condition sensors for sensing one or more preselected conditions of the receptacle; and a wireless transmitter for transmitting a signal identifying the respective receptacle and whether a preselected condition has been sensed.

The method and system of the present invention can thus use a computerized electronic RF chip, and/or an IR transmitter, that sends a unique code through space. This unique code varies from event to event as to what occurs to the receptacle to which the chip is attached. Unique codes would be used for movements of the box, for opening of the box, for temperature changes of the box, for weight changes in the contents of the box, or for just indicating the box has not been moved and no other event has occurred in a predetermined time interval. The happenings of each receptacle can be analyzed and used to trigger commands through a computer program, and to activate, through different switches, various types of devices like a siren, a door lock, a camera, etc. The control can use a computer program that can be installed in a personal computer, lap-top compact, notebook computer, PDA, cellular phone, etc. To manage the system one can use the PC/Notebook/PDA directly, or can connect and control the managing computer through the internet, intranet, wireless communication, GPRS, Bluetooth or other communication method available to transfer commands to remote computers.

It will thus be seen that the dynamic stock tracking system of the present invention is capable of providing the user with an active report, at a glance, of the actual stock status at any time such a report may be desired, and is also capable of actuating a control or alarm device if warranted by a sensed condition.

Further features and advantages of the invention will be apparent from the description below.

### BRIEF DESCRIPTION OF THE DRAWINGS

The invention is herein described, by way of example only, with the reference to the accompanying drawings, wherein:

FIG. 1 illustrates one type of receptacle, particularly for stocks of precious stones or jewelry, for use in a dynamic stock tracking system constructed in accordance with the present invention;

FIG. 2 more particularly illustrates the structure of the receptacle of FIG. 1;

FIG. 3 illustrates another receptacle constructed in accordance with the present invention to include a large number of sensors for sensing various preselected conditions;

FIG. 4 is a schematic top view of the receptacle of FIG. 3;

FIG. 5 is a schematic bottom view of the receptacle of FIG. 3;

FIG. 6 illustrates a plastic bag-type receptacle constructed in accordance with the present invention to include documents, such as certificates, in addition to the precious stones or jewelry to be dynamically tracked;

FIG. 7 illustrates the invention implemented in a folded-paper type receptacle;

FIG. 8 illustrates the invention implement in a weapons-box receptacle;

FIG. 9 is a computer layer and communication traffic diagram of a system constructed in accordance with the present invention;

FIG. 10 is a communication channel diagram illustrating the communication between the identification tags in a plurality of receptacles and various controllers to be controlled by the conditions sensed in the receptacles;

FIG. 11 is a general hardware block diagram illustrating the communication channels in the diagram of FIG. 10; and

FIG. 12 is a general software block diagram illustrating the communication between the identification tags and the various control devices.

It is to be understood that the foregoing drawings, and the description below, are provided primarily for purposes of facilitating understanding the conceptual aspects of the invention and possible embodiments thereof, including what is presently considered to be a preferred embodiment. In the interest of clarity and brevity, no attempt is made to provide more details than necessary to enable one skilled in the art, using routine skill and design, to understand and practice the described invention. It is to be further understood that the embodiments described are for purposes of example only, and that the invention is capable of being embodied in other forms and applications than described herein.

### DESCRIPTION OF PREFERRED EMBODIMENTS

The Construction of Stock Tracking Receptacles

As indicated earlier, the dynamic stock tracking system of the present invention is particularly useful for tracking precious stones and jewelry, and therefore the receptacles used would be of the conventional type for holding precious stones and jewelry, but modified to accommodate the identification device and the various sensors in accordance with the present invention.

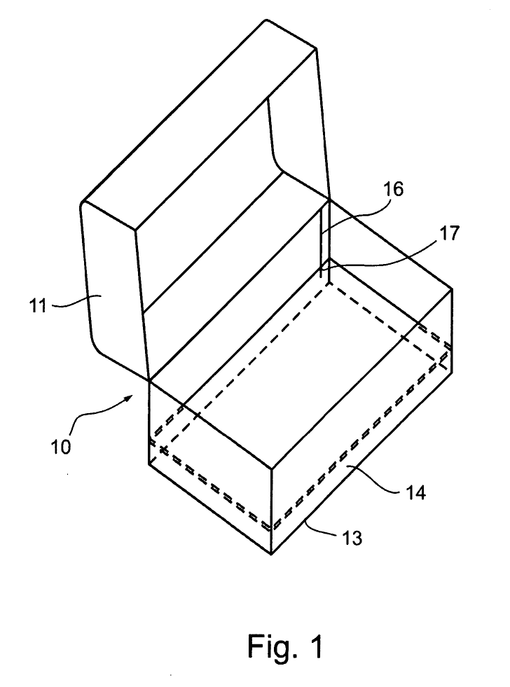

For purposes of example, FIGS. 1-5 illustrate the invention implemented in a sorting box-type receptacle used for holding diamonds and other precious stones;

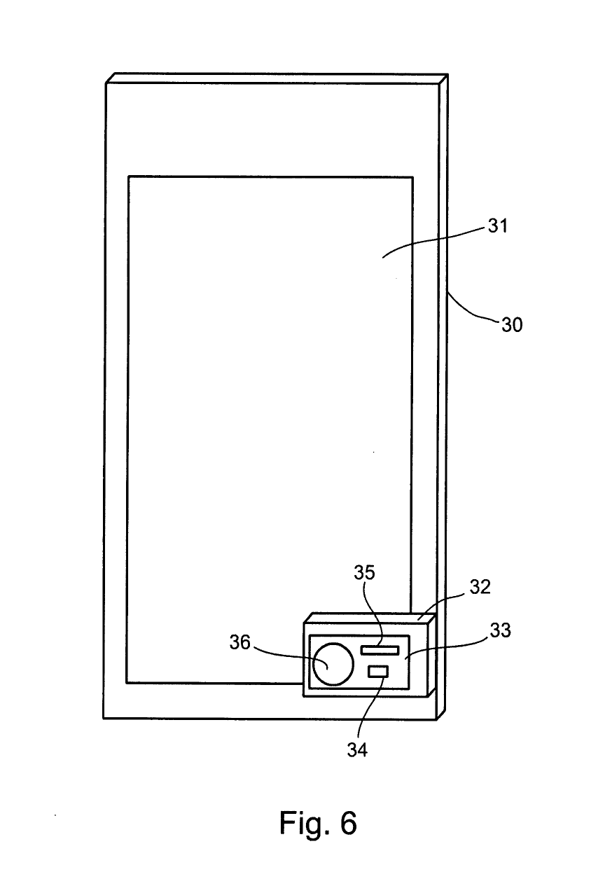

FIG. 6 illustrates the invention implemented in a plastic bag-type receptacle for holding diamonds or other precious stones together with documents, such as certificates, relevant to the diamonds or precious stones within the plastic bag; and

FIG. 7 illustrates the invention implemented in a folded-paper type receptacle, commonly called a “briefke”.

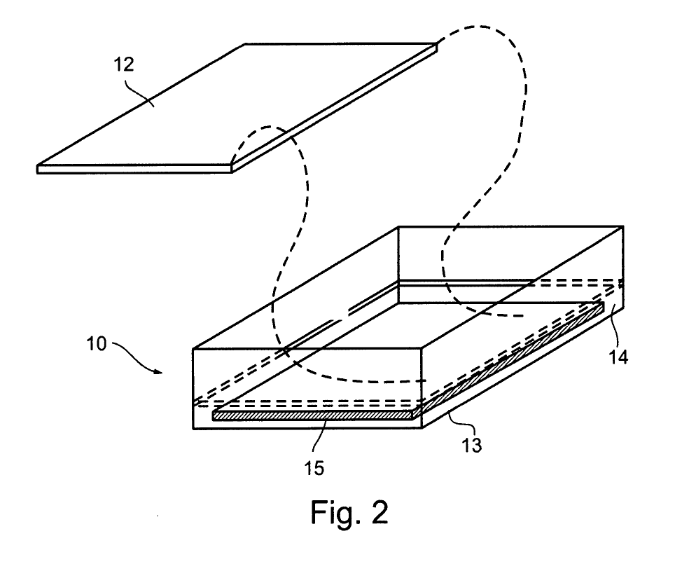

The sorting box illustrated in FIGS. 1 and 2, and therein generally designated 10, is adapted to contain a number of diamonds or other precious stones (not shown) and is closed by a pivotal lid 11. The interior of box 10 includes a raised bottom 12 for receiving the precious stones. Bottom 12 is raised above the bottom wall 13 of the box to define a space 14 for receiving the tag or identification device, in this case an RFID (radio frequency identification device) 15, as shown in FIG. 2. RFID 15 identifies the respective box, and also contains information regarding the contents of the box.

Sorting box 10 illustrated in FIG. 1 further includes a sensor 16 for automatically sensing the opening and closing of the box. Sensor 16 may be, for example, a spring-urged pin engageable with lid 11 when the lid is moved to its closed position. Thus, pin 16 is normally urged to an outer position, but when lid 11 is closed, the lid presses the pin to its inner position. Pin 16 actuates a microswitch, schematically shown at 17, so as to close it when the pin is pressed downwardly to its closed position by lid 11, and to open it when the pin is spring-urged to its outer position by the opening of the lid 11, or vice versa.

Sensor 16 thus senses each movement of lid 11 to its open and closed positions. This information is communicated to the RFID 15 within the space 14 between the raised bottom 12 and the bottom wall 13, and is stored therein. It will thus be seen that sensor 16 senses each opening and closing of box 10 and records such information in the RFID 15.

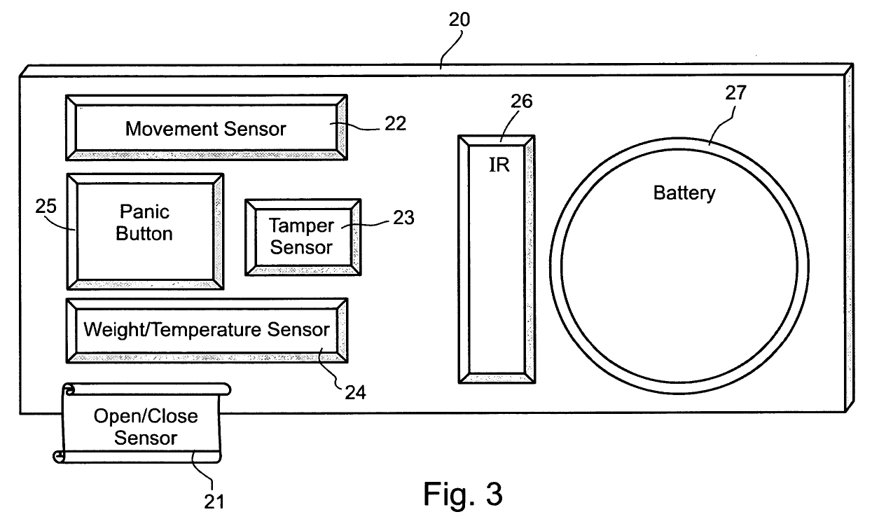

FIGS. 3-5 diagrammatically illustrate another sorting box constructed as described above with respect to FIGS. 1 and 2, but including many additional sensors. Thus, sorting box 20 includes, in addition to an open/close sensor 21, which may be constructed as described above with respect to sensor 16, also a movement sensor 22, such as an inertia device which is actuated whenever the sorting box is moved. Movement sensor 22 thus enables the RFID within the box (corresponding to RFID 15 in FIG. 2) to record each time the sorting box is physically moved.

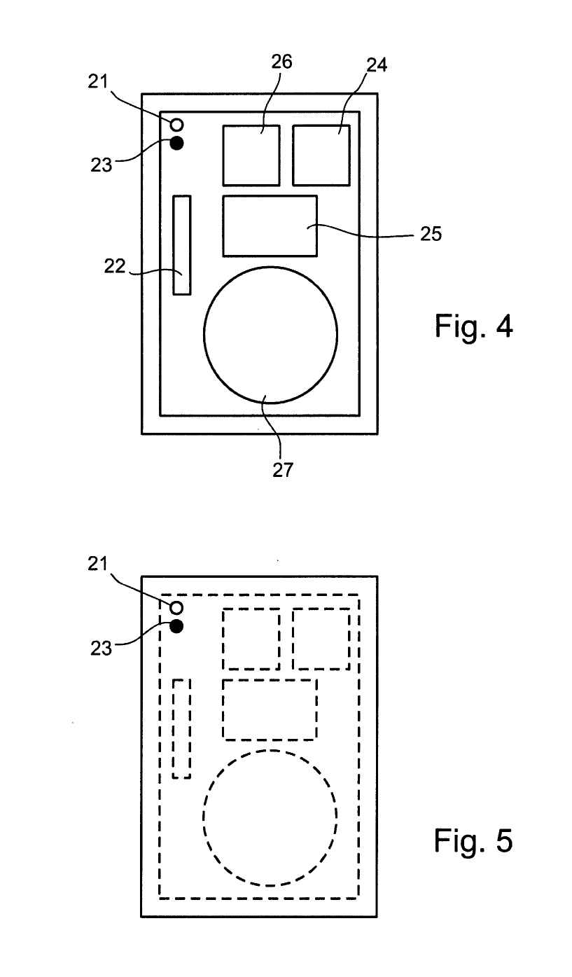

Sorting box 20 illustrated in FIGS. 3-5 further includes a tamper sensor 23 which senses any lifting of the box off a table or other horizontal support. FIGS. 4 and 5 schematically illustrate one possible construction of a tamper- or lift-sensing sensor. Such a sensor may include, for example, a spring-urged pin or button projecting from the bottom wall of the box, as shown in FIG. 5, such that the pin or button is normally spring-urged outwardly, but is pressed inwardly whenever the box is received on a table or other horizontal support. Thus, sensor 23 will thereby record each lifting of the box from the table or horizontal support, and store such information in the RFID (e.g., RFID 15, FIG. 2) of the respective box.

Sorting box 20 further includes a weight and/or a temperature sensor, schematically shown 24 in FIG. 3. A conventional weight sensor can be used, which actually weighs the box 20 and its contents, such that any change in the weight (e.g., by the removal or addition of a precious stone) will be sensed and recorded in the respective RFID. Similarly, any suitable temperature sensor could be used for sensing and recording in the RFID the ambient temperature of the region in which the box 20 is located, e.g., to record the movement of the box out-of-doors or to another location of a different temperature.

Sorting box 20 illustrated in FIGS. 3-5 further includes a panic button 25 which may be manually depressed in order to actuate an alarm or control device if needed. For example, actuation of panic button 25 could be used for energizing an audible alarm device, for automatically locking doors, for transmitting a distress signal to a remote location, and/or for performing any other function that may be desired.

Sorting box 20 illustrated in FIGS. 3-5 also includes an infrared identification device (IRID) 26, instead of, or in addition to, the RFID 15 (FIG. 2), for identifying the respective box, storing information concerning its contents, and recording the occurrence of any of the conditions sensed by the above-described sensors 21-24, or the actuation of the panic button 25. Whereas an RFID can be used for transmitting the information stored therein to a distant or remote location, an IRID can be used for transmitting the information stored therein to a more proximal location, such as to another side of the same room as the sorting box.

Finally, as shown in FIGS. 3-5, a battery 27 is provided for powering the various electronic components contained within the box.

It will thus be seen that the various sensors illustrated in sorting box 20 of FIGS. 3-5 will sense the various conditions of the respective sensors, and will record the sensed conditions as they occur within the IRID 26, and/or the RFID corresponding to RFID 15 in FIG. 2.

FIG. 6 illustrates another type of receptacle, namely a plastic bag, that may be used in the dynamic stock tracking system according to the present invention. The plastic bag illustrated in FIG. 6, and therein designated 30, is designed to hold one or more jewelry items, rather than diamonds or other precious stones, in a manner to enable continuous tracking of the jewelry items within the bag. Thus, plastic bag 30 illustrated in FIG. 6 includes space for receiving also a certificate 31 relating to the one or more jewelry items contained within the bag, and a small pocket 32 at the bottom of the bag for receiving an identification device 33, e.g., an RFID or an IRID, together with one or more of the condition sensors described above, such as a movement sensor 34 and a weight sensor 35, as well as a battery 36 for powering the electronic components. While FIG. 6 illustrates only two such sensors, it will be appreciated that many other types of sensors could be included according to the particular application, for example those illustrated in FIGS. 3-5.

FIG. 7 illustrates a folded-paper type receptacle 40, commonly called a briefke, widely used for holding a plurality of diamonds or other gemstones 41, and similarly equipped with an identification device 43, e.g., an RFID or an IRID. In this case, identification device 43 also includes a movement sensor 44, a weight sensor 45, and a battery 46 for powering the electronic components of the identification device. Identification device 43 may be loosely received within the briefke, or may be bonded, as by a pressure-sensitive adhesive, either to its inner surface or its outer surface.

While FIG. 7 illustrates only two such sensors, it will also be appreciated that one or more of the other types of sensors illustrated in FIGS. 3-5 could also be included, according to the particular application.

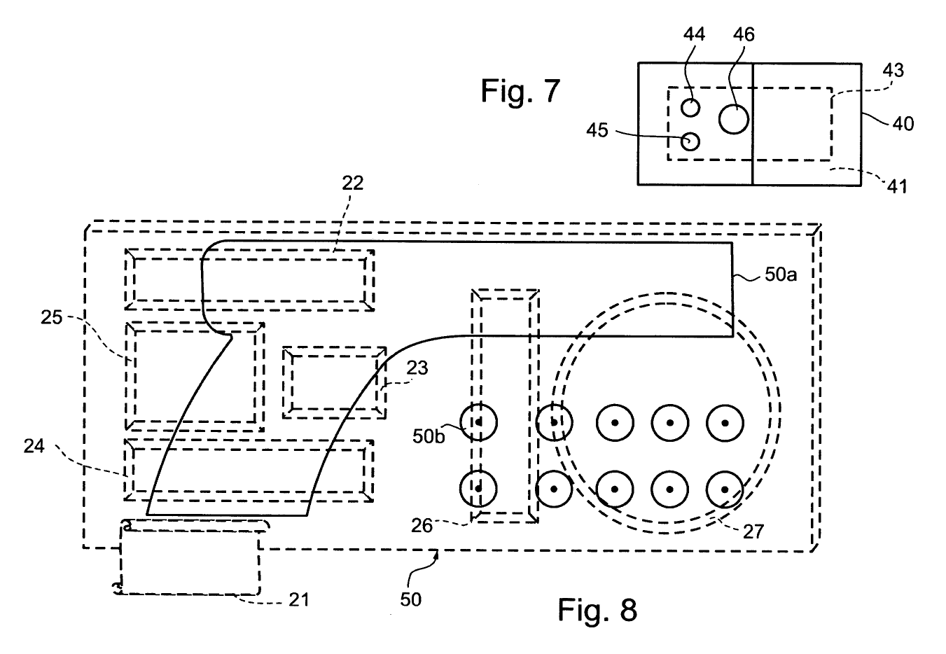

FIG. 8 illustrates the invention implemented in a receptacle, generally designated 50, for holding a weapon, munitions, or the like, such as to enable the contents of the receptacle to be closely tracked. In this example, the receptacle 50 is illustrated as holding a handgun 50a, and/or a plurality of bullets 50b. Receptacle 50 may be constructed similarly to receptacle 10 illustrated in FIGS. 1-5, to include a pivotal cover, a raised bottom plate, a bottom wall to define a space for receiving the tag or identification device, e.g., an RFID, corresponding to 15 in FIGS. 1 and 2, or an IRID corresponding to 20 in FIGS. 3-5, and to include one or more of the condition sensors 21-25, the IRID 26 and the battery 27 illustrated in FIG. 3.

Overall System

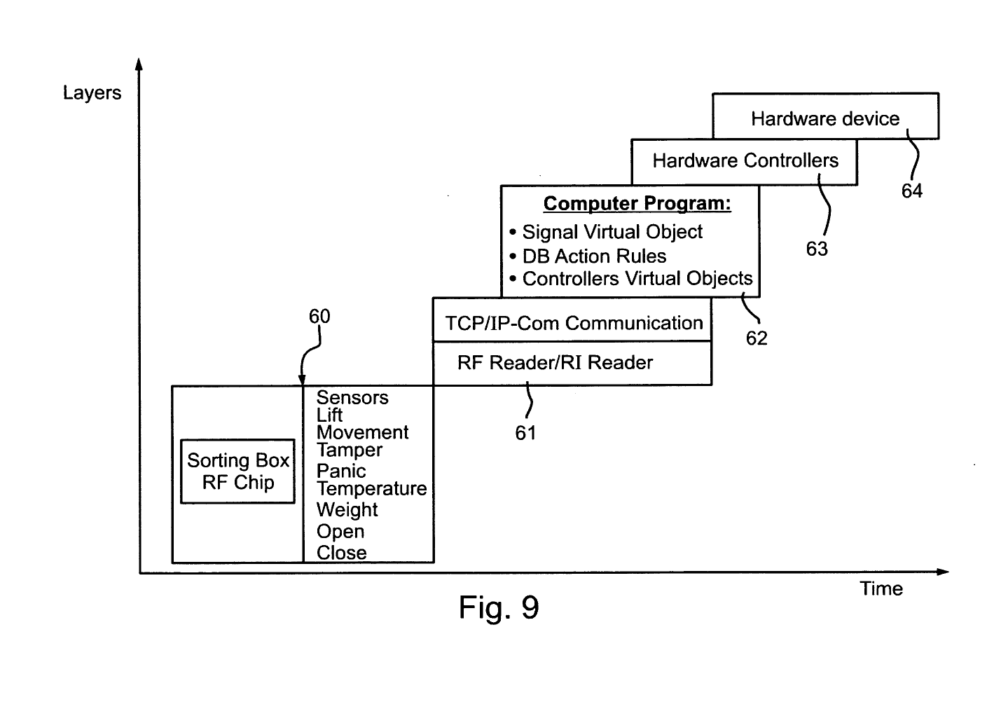

FIGS. 9-12 are diagrams illustrating the overall system. The system is generally built of two parts: hardware, and software. Each part is responsible for the information transfer and analysis in a different level. Both the hardware level, and the software level, are spread over the complete system, as shown in the computer layer and communications traffic diagram of FIG. 9. For purposes of example, the diagrams of FIGS. 9-12 are applicable for dynamically tracking stock in the form of precious stones or jewelry as illustrated particularly in FIGS. 1-7.

Thus, as shown in FIG. 9, the lowest level 60 is occupied by the sorting box including the identification device (RFID and/or IRID), together with the various condition sensors included in the box. For purposes of example, layer 60 illustrated in FIG. 9 includes the following sensors: lift, movement, tamper, panic, temperature, weight, open and closed.

The next level indicated at 61 includes the RF reader and/or the IR reader, and the TCP/IP communication devices associated therewith, such as a personal computer, a lap-top computer, a notebook computer, PDA, cellular telephone, etc. The computer can be used to manage the system directly, or can be connected and controlled through the internet, intranet, wireless communication, GPRS, bluetooth, or other communication method available to transfer commands to remote computers.

FIG. 9 illustrates the compute program at level 62, the hardware controllers at level 63, and the various control hardware devices at level 64.

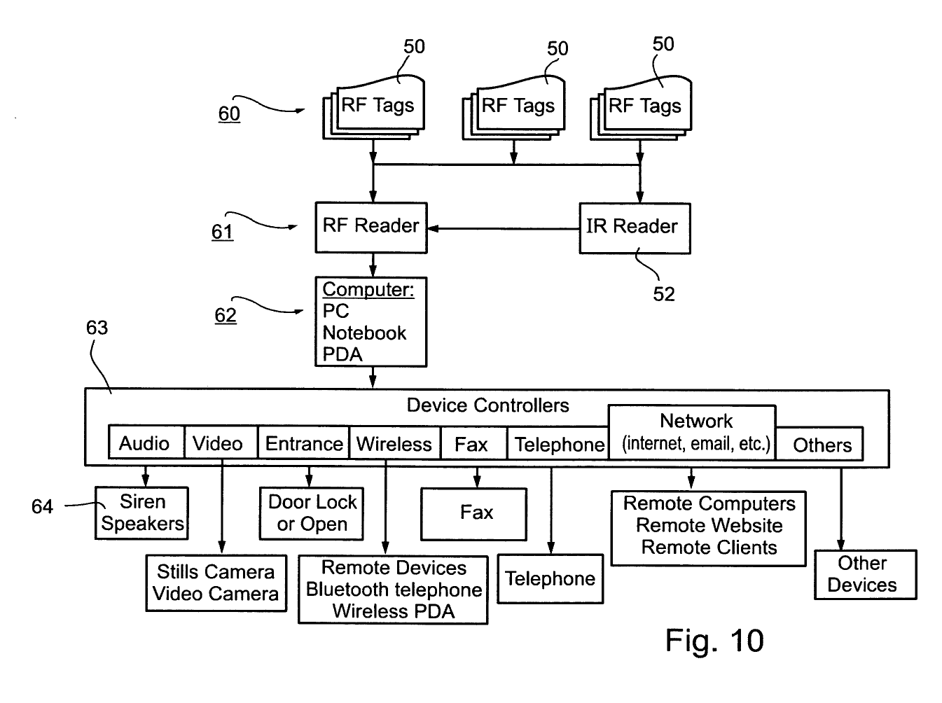

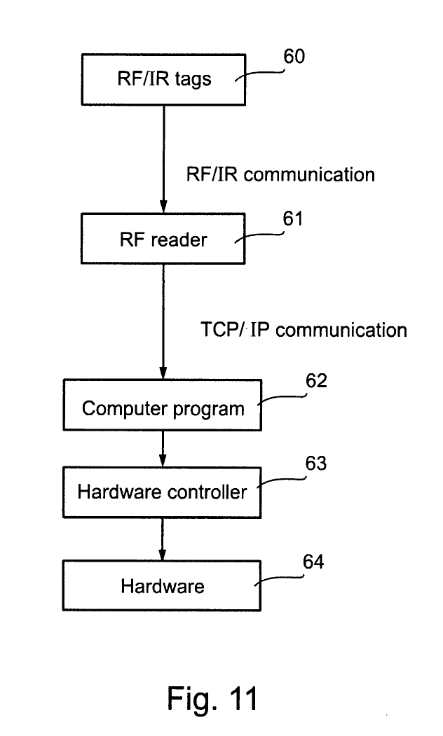

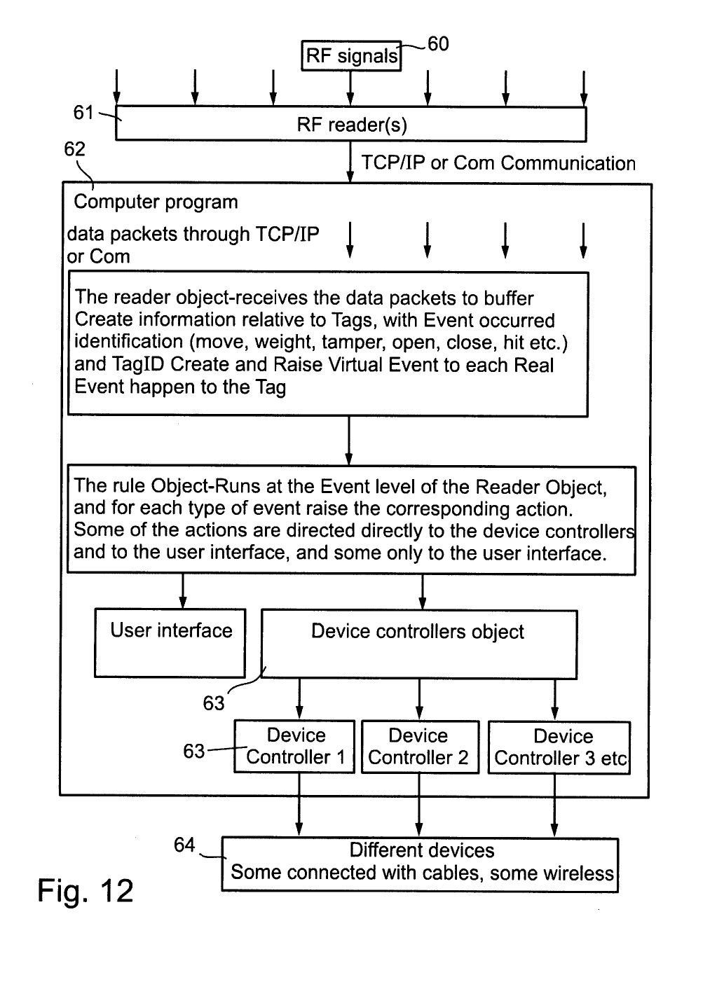

FIG. 10 schematically illustrates an example of the hardware content of each of the levels 60-64; FIG. 11 schematically illustrates the flow of information from one level to the next; and FIG. 12 is a general software block diagram illustrating the overall operation of the system.

Thus, the general hardware block diagram of FIG. 11 illustrates the flow of information from the RF/IR tags 60 to the RF reader 61 via the RF/IR communication channel, then to the computer program 62 via the TCP/IP communication channel, and finally from the hardware controllers 63 to the different control devices 64.

In the software level, the software is a combination of standard software provided with all standard controllers and devices, such as the audio card, video card, etc., as well as software specifically prepared for the dynamic stock tracking system of the present invention. The latter software includes the RF tags 60 and reader software 61, the software that activates the controllers 63, etc. Such software elements include the following:

At the Tag Reader Level 61, the communication transmitting software activates the RF chip, and the communication receiver software activates the RF reader.

The computer or PDA level 62 includes: the RF layer interface software/object between the communications from the reader (through TCP/IP communication) to the computer; the interface layer to the user; the rules layer; the triggered actions layer; and the software which control the controllers.

The controllers level 63 includes: the controller's software, which may be standard devices. At the software level, each layer receives information from the previous layer, computes it and transfers the computed information to the next layer. All software components at the first hardware level (i.e., tags/readers) transfer the information after additional computing up to the computer hardware.

At the computer hardware level 64, the software analyzes the information received from the previous level, “understanding” the different events occurred to the target objects (i.e. diamond and gems in small boxes), and triggers the correct action required. The software sends the required action to the controller that activates in its time the equivalent device.

The different levels and objects of software as shown in FIG. 12, are as follows:

The RF tag 60 includes firmware that communicates with the hardware and, according to the conditions sensed by its different sensors (lift, movement, temperature, weight, temper, open, close, panic etc.) it sends a different and unique RF code signal. If an IR sensor is also included, the Tag can also send a unique IR code signal.

The RF reader 61 includes standard firmware that communicate with the hardware, receives the RF and/or IR signals, translates it to TCP/IP communication, and sends packet of information when the internal buffer is filled.

At the computer level 62, the software is built of different components that operate as one consistent unit. This unit is connected at one side to the RF reader using TCP/IP communication; at the other side, this unit is connected to the different devices using the device controllers 63. The program receives communication packets from one side, breaks it to analyze the data, builds readable information out of it, and then creates events according to the different types of information. As a response to the different events, a set of rules are generated, and if a rule is found to be true then the relevant action(s) equivalent to that rule is performed, activating the corresponding device controller 63 and then the device 64.

Other Variations, Modifications and Applications of the Invention

One particularly suitable application of the invention, called “StockGuard”™, is for controlling the office stock by continuously informing the user where the stock is, whether it moved, faded-out-of-sight, disappeared, transferred from one safe to another safe, returned from the broker, given to the broker, left the office, etc. This application may be involved when the stock is in the office, or when carried during a trip, in which case a portable computer could be used.

Another application, called “TourGuard”™, operates similarly to the above application but uses a PDA. This application will provide the user with the same alerts regarding the various events that may have occurred. In this application, the system would have the ability to respond to the events by updating a remote website, ring a Bluetooth telephone, or merely actuate an alarm.

A still further application, called “ShowTime”™, uses a real-time location system to provide the exact location of a receptacle. This application is particularly useful in a “show event”, when all users use the same system to provide the location of their respective goods.

The invention can also be used for dynamically tracking various actions regarding weapons and arms in the same manner as described above with respect to diamonds and gems in sorting boxes and paper parcels. For example, the novel dynamic tracking system could be implemented with respect to weapons and arms in the following manner:

1. To all weapons and arms RF tags will be attached (fixed and hidden)

2. All weapon and arms will be listed in the stock program, with reference tag identification and other weapon identifications (weapon type, identification, etc.)

3. All movements, as well as other events relevant to weapons (e.g., movement, lifting, touching, etc.) will be tracked, and stored in the system log

4. A stock inventory will be available whenever desired, together with information concerning all events experienced by the respective weapon.

While the main application of the invention is for dynamically tracking diamonds, gems, jewelry and weapons as described above, the invention can be implemented in many other applications for dynamically tracking expensive tools or other such items subject to theft or loss.

While the invention has been described with respect to several preferred embodiments, it will be appreciated that these are set forth merely for purposes of example, and that many other variations, modifications and applications of the invention may be made.

What is claimed is:

1. A dynamic stock tracking method for continuously tracking stock contained within a receptacle, comprising:
applying to the receptacle an identification device identifying the respective receptacle and containing information regarding its contents;
applying to the receptacle one or more condition sensors for sensing one or more preselected conditions of the receptacle when at a particular location;
transmitting by wireless to another location, a signal identifying the respective receptacle and whether a preselected condition has been sensed;
receiving the transmitted signal at the another location;
and utilizing the received signal for continuously tracking the stock contained within the receptacle and whether a preselected condition has occurred.

2. The method according to claim 1, wherein said identification device includes a memory for storing information regarding the sensing of said one or more preselected conditions, and for including said stored information in the signal transmitted to the another location.

3. The method according to claim 2, wherein said signal is transmitted to said another location at periodic intervals.

4. The method according to claim 2, wherein said signal is transmitted to the another location in response to an interrogating signal.

5. The method according to claim 1, wherein said identification device is a radio frequency identification device (RFID).

6. The method according to claim 1, wherein said identification device is an infrared identification device (IRID).

7. The method according to claim 1, wherein said one or more preselected conditions includes a lifting of the receptacle off a table or other horizontal support.

8. The method according to claim 1, wherein said one or more preselected conditions includes an opening and/or closing of the receptacle.

9. The method according to claim 1, wherein said one or more preselected conditions includes a touching of the receptacle.

10. The method according to claim 1, wherein said one or more preselected conditions includes a physical movement of the receptacle.

11. The method according to claim 1, wherein said one or more preselected conditions includes a change in weight of the receptacle.

12. The method according to claim 1, wherein said one or more preselected conditions includes a change in the ambient temperature of the receptacle.

13. The method according to claim 1, wherein said one or more preselected conditions includes the absence of physical movement of the receptacle for a predetermined time period.

14. The method according to claim 1, wherein said wireless signal is used to actuate a signaling, control or communication device.

15. The method according to claim 1, wherein said stock is precious gems or jewelry contained within said receptacle.

16. The method according to claim 1, wherein said stock is arms or weapons.

17. A dynamic stock tracking system for continuously tracking stock, comprising:
a receptacle for receiving said stock;
an identification device carried by said receptacle for identifying the receptacle and containing information regarding its contents;
one or more condition sensors for sensing one or more preselected conditions of the receptacle;
and a wireless transmitter for transmitting a signal identifying the respective receptacle and whether a preselected condition has been sensed.

18. The system according to claim 17, wherein said identification device includes a memory for storing information regarding the sensing of said one or more preselected conditions, and for including said stored information in the signal transmitted to the another location.

19. The system according to claim 17, wherein said one or more preselected conditions includes a lifting of the receptacle off a table or other horizontal support.

20. The system according to claim 17, wherein said one or more preselected conditions includes an opening and/or closing of the receptacle.

21. The system according to claim 17, wherein said one or more preselected conditions includes a touching of the receptacle.

22. The system according to claim 17, wherein said one or more preselected conditions includes a physical movement of the receptacle.

23. The system according to claim 17, wherein said one or more preselected conditions includes a change in weight of the receptacle.

24. The system according to claim 17, wherein said one or more preselected conditions includes a change in the ambient temperature of the receptacle.

25. The system according to claim 17, wherein said one or more preselected conditions includes the absence of physical movement of the receptacle for a predetermined time period.

26. The system according to claim 17, wherein said wireless signal is transmitted at periodic time intervals.

27. The system according to claim 17, wherein said wireless signal is used to actuate a signaling, control or communication device.

28. The system according to claim 17, wherein said stock is precious gems or jewelry contained within said receptacle.

29. The system according to claim 28, wherein said receptacle is a box receptacle.

30. The system according to claim 28, wherein said receptacle is a plastic bag receptacle.

31. The system according to claim 28, wherein said receptacle is a folded-paper receptacle.

32. The system according to claim 17, wherein said stock is arms or weapons.
